(19) United States
(12) Patent Application Publication
(10) Pub. No.: US 2008/0049252 A1
(43) Pub. Date: Feb. 28, 2008

(54) Image saving system, scanner device, and image saving method

(75) Inventor: Kenji Sakuda, Suwa-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/894,894

(22) Filed: Aug. 22, 2007

(30) Foreign Application Priority Data
Aug. 22, 2006 (JP) 2006-225595

(51) Int. Cl. G06F 3/12

(52) U.S. Cl. 358/1.15

(57) ABSTRACT

An image saving system for reading and saving an image, including an image storage device, and a scanner device connected to the image storage device via a network, in which the scanner device includes a read unit which reads an image and produces image data, a control point unit which acts as a control point in network plug-and-play, and a device unit, the device unit notifies the control point unit that the device unit is a storage device in the network plug and play, and the device unit sends the image data with a predetermined reserved file name to the image storage device and saves the image data with the predetermined reserved file name to the image storage device when the device unit receives a file transmission request which designates the predetermined reserved file and is sent in response to a user's instruction which commands the device unit to save the image data obtained by allowing the scanner device to read the image mounted on the scanner device to the image storage device.

### BACKGROUND

The entire disclosure of Japanese Patent Application No. 2006-225595, filed Aug. 22, 2006 is expressly incorporated by reference herein.

1. Technical Field

The present invention relates to a technology for saving an image read by a scanner device by directly transmitting image data to an image storage device through a network.

2. Related Art

Plug-and-play is a well-known technology which enables connection and disconnection of peripheral devices to and from a computer at any time after the computer has been started up. In recent years, Universal Plug and Play (hereinafter, referred to as “UPnP,” UPnP is a trademark of UPnP Implementers Corporation) technology which is an extension of plug-and-play to networks has been developed. The use of UPnP enables network devices to be connected to or disconnected from a network at any time. Herein, the architecture for realizing plug-and-play on a network is termed as “network plug-and-play.”

However, as for UPnP, the standard of specifications thereof have not yet been specified to the extent of application layers. Guidelines for enabling interoperability of apparatuses from different vendors for digital contents, such as moving images, audio, and still images have been drawn up by the Digital Living Network Alliance (DLNA) and are published as “DLNA guidelines v1.0.” The DLNA guidelines v1.0 adopt UPnP and Hyper Text Transfer Protocol (HTTP) as protocols for device connection and content transfer.

In a system based on the DLNA guidelines v1.0 (hereinafter, referred to as “DLNA system”), digital contents can be directly transmitted and received between digital media servers (DMS) which are devices providing digital contents and digital media players (DMP) which are devices used for playing digital contents. For example, in a DLNA system in which a computer with a hard disk having a large storage capacity (hereinafter, referred to as “server”) is a DMS and a digital television set (hereinafter, referred to as “DTV”) is a DMP, the server directly sends a list of still images (list of file names, or the like) stored in the hard disk to the DTV, and then sends the still images selected from the list to the DTV to display the selected still images on the DTV.

However, it has not been possible to directly send and save images read by a scanner device incorporated into a DLNA system to a server. This is because of the following reason. The DLNA system treats the DMS as a storage device capable of storing images and audio, which is, for example, a computer, a hard disk recorder, or a DVD recorder. That is, since the scanner device is not assumed as the DMS, there was no way to establish transmission and saving of images read by the scanner device to the server. Accordingly, for example, until now, images read by the scanner device have been saved in a manner such that images read by the scanner device are temporarily stored in a personal computer (PC) connected to the server through a local area network (LAN), and then the stored images are sent to the server from the PC through the network. There is a problem with this method in that a user must have a PC connected to the network as well as the scanner device.

The problem is encountered not only in the DLNA system but is also common in the cases in which image data obtained by allowing a scanner device to read an image is sent to a server through a network and saved in the server.

### SUMMARY

An advantage of some aspects of the invention is that it provides a technology which can directly send an image read by a scanner device to an image storage device through a network and save the image to the image storage device.

A first aspect of the invention provides an image saving device for reading and saving an image, including an image storage device, and a scanner device connected to the image storage device via a network, in which the scanner device includes a read unit which reads an image and produces image data, a control point unit which acts as a control point in network plug-and-play, and a device unit. The device unit notifies the control point unit that the device unit is a storage device in the network plug-and-play. The device unit sends the image data with a predetermined reserved file name to the image storage device and save the image data with the predetermined reserved file name to the image storage device when the device unit receives a file transmission request which designates the predetermined reserved file name and is sent in response to a user's instruction which commands the device unit to read the image mounted on the scanner device and save the image data.

In the image saving system having the structure, the device unit notifies the control point unit that the device unit is the storage device. Accordingly, at least the control point unit can send the file transmission request to the device portion as a control process of the storage device. Further, the device unit sends the image data with the reserved file name to the image storage device and allows the image data to be saved in the storage device with the reserved file name when it receives the file transmission request which designates the reserved file name. Accordingly, it is possible to save the image read by the scanner device to the image storage device by directly sending the image data to the storage device via the network.

In the image saving system, it is preferable that the device unit reads the image by the read unit and produces the image data after it receives the file transmission request.

Thanks to the structure, it is possible to sequentially send the produced image data to the image storage device, and thus it is possible to suppress the amount of a buffer which temporarily stores the produced image data to a small size.

In the image saving system, it is preferable that the image storage device acts as the storage device in the network plug-and-play, the control point unit sends the reserved file name to the image storage device by acquiring the reserved file name from the device unit, and the image storage device sends the file transmission request to the device unit.

Thanks to the structure, the control point unit can send the reserved file name to the image storage device as a control process of the storage device. Further, since the file transmission request designating the reserved file name is sent from the image storage device to the device unit, the device unit can produce the image data by reading the image and send the image data to the image storage device.

In the image saving system, it is preferable that the control point unit acquires the reserved file name from the device unit and sends the file transmission request to the device unit.

Thanks to the structure, the control point unit sends the file transmission request to the device unit as a control process of the storage device. Accordingly, the device unit can read the image, produce the image data, and send the image data to the image storage device.

A second aspect of the invention provides a scanner device connected to an image storage device via a network and including a read unit producing image data by reading an image, a control point unit acting as a control point in network plug and play, and a device unit. The device unit notifies the control point unit that the device unit is a storage device in the network plug-and-play. The device unit sends and saves the image data with a reserved file name to the image storage device if the device unit receives a file transmission request which designates the reserved file name and is sent in response to a user's instruction which commands the device unit to read an image mounted on the scanner device and store image data to the image storage device.

Thanks to the structure, at least the control point unit can send the file transmission request to the device unit as a control process of the storage device since the device unit notifies the control point unit that the device unit is a storage device. The device unit saves the image data with the reserved file name to the image storage device when it receives the file transmission request which designates the reserved file name. Accordingly, it is possible to save the image read by the scanner device to the image storage device by directly sending the image data to the image storage device via a network.

The invention can be realized in various forms, for example, an image saving method, a computer program for implementing an image saving method or a function of an image saving system, a recording medium storing the computer program therein, and a data signal embodied in transporting waves, or the like.

### BRIEF DESCRIPTION OF THE DRAWINGS

The invention will be described with reference to the accompanying drawings, wherein like numbers reference denote like elements.

FIG. 1 is a schematic view illustrating a structure of an image saving system according to the invention.

FIG. 2 is a block diagram illustrating structures of a multifunction device 100 and a server 200 shown in FIG. 1.

FIG. 3 illustrates a sequence of an image saving method in an image saving system 1000.

FIG. 4 is an explanatory view illustrating a scan menu screen displayed on a display unit 15 in Step [1].

FIG. 5 is an explanatory view illustrating a scan menu screen W1 displayed on a display unit 15 in Step [8].

FIG. 6 is a sequence view illustrating a sequence of an image saving method according to the invention.

### DESCRIPTION OF EXEMPLARY EMBODIMENTS

Hereinafter, embodiments of the invention will be described with reference to the accompanying drawings in the following order;

A: First embodiment;

B: Second embodiment; and

C: Modification

### A: First Embodiment

### A1: System Structure

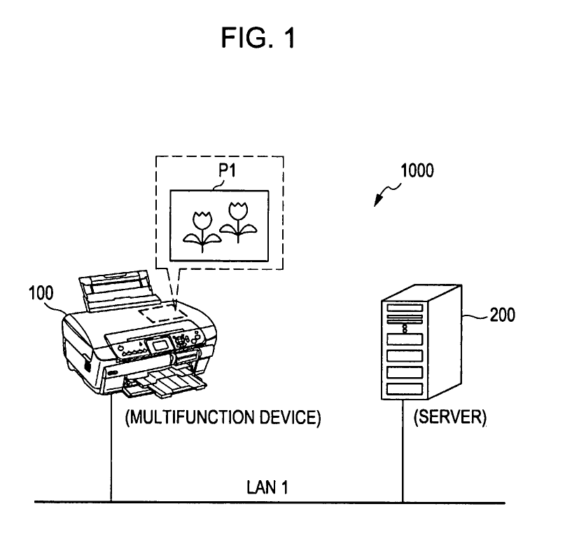

FIG. 1 shows an overall structure of an image saving system according to the invention. The image saving system 1000 constitutes a DLAN system and is composed of a multifunction device 100 and a server 200. The multifunction device 100 and the server 200 are connected to a local area network LAN1. The multifunction device 100 integrates a printer function and a scanner function. The server 200 can store a large amount of image data. In the image saving system 1000, the multifunction device 100 is structured in a manner such that an image P1 which is in a printed form is read and image data produced from the read image is saved in the server 200. The local area network LAN1 may be a wired network based on the standard IEEE 802.3 or a wireless network based on the standard IEEE 802.11b/g/a.

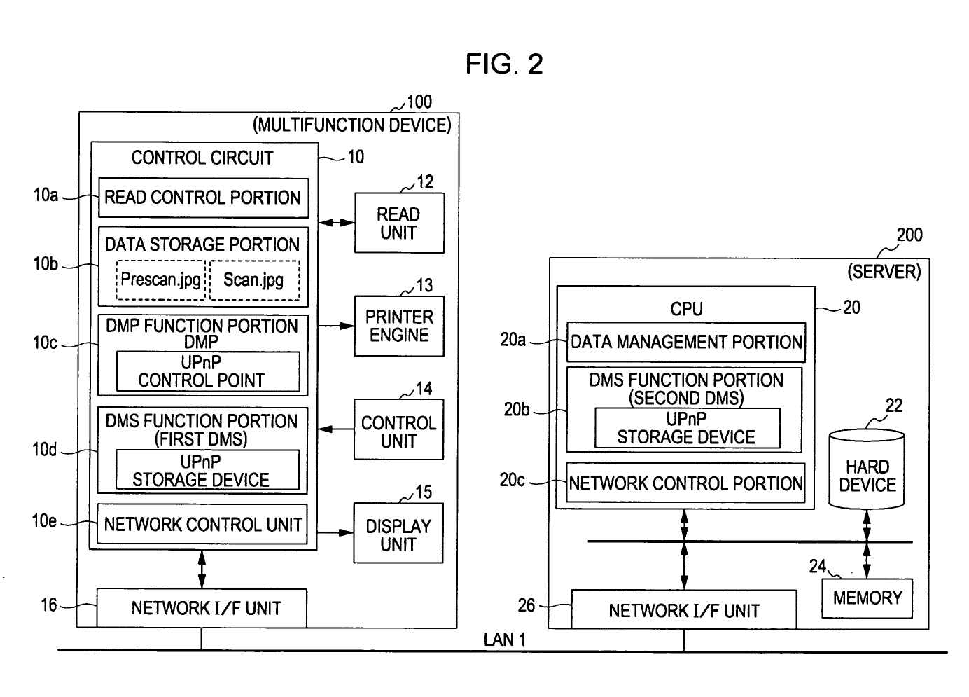

FIG. 2 is a block diagram showing structures of the multifunction device 100 and the server 200 shown in FIG. 1. The multifunction device 100 includes a control circuit 10, a read unit 12, a printer engine 13, a manipulation unit 14, a display unit 15, and a network interface unit 16. The read unit 12 produces image data by scanning an image. The printer engine 13 includes a carriage on which an ink cartridge is mounted and feeding and discharging motors (not shown). The printer engine 13 substantially performs printing. The manipulation unit 14 includes a plurality of manipulation buttons and sends user instructions to the control circuit 10. The display unit 15 includes a liquid crystal panel and displays various menu screens thereon. The network interface unit 16 is composed of an interface group for establishing a physical connection to the local area network LAN1 and a data link with a data transmission destination. The control circuit 10 includes a central processing unit (CPU), memory, and the like, which are not shown in the figures. The control circuit 10 is composed of a read control portion 10a, a data storage portion 10b, a DMP function portion (hereinafter, referred to as “DMP”) 10c, a DMS function portion (hereinafter, referred to as “DMS”) 10d, and a network control portion 10e.

The read control portion 10a controls the read unit 12 so as to scan an image under a predetermined scan condition. The data storage portion 10b temporarily stores image data obtained by scanning. The DMP 10c is a functional portion which functions as DMP in a DLNA system, acts as a control point in UPnP, and performs content management and format conversion of images on the basis of the standard UPnP AV v1.0. A first DMS 10d functions as a DMS (storage device in UPnP) in a DLNA system. Here, the phrase “a first DMS 10d functions as a DMS” not only means that the first DMS 10d is a storage device having a large storage capacity but also means that the first DMS 10d can execute data transmission processing by receiving a data acquisition request for at least the DMS (i.e. for storage device in UPnP). The network control unit 10e executes protocols including Transmission Control Protocol (TCP) for a transport layer, User Datagram Protocol (UDPP), and Internet Protocol (IP) for a network layer, and controls the network interface unit 16, thereby enabling data transmission via the local area network LAN1.

The UPnP devices generally act as either devices which provide a plurality of services or control points which discover or control other devices on a network. The multifunction device 100 includes both a device and a control point therein. The first DMS 10d acting as the device notifies the DMP 10c acting as the control point that it is a UPnP storage device which provides a storage service. Here, the DMP 10c and the first DMS 10d correspond to a control point unit and a device unit, respectively, in claims. The image saving system 1000 may have a structure including only a scanner device instead of including the multifunction device 100.

The server 200 includes a CPU 20, a hard disk 22, a memory 24, and a network interface unit 26. These elements are connected to each other as internal devices. The network interface unit 26 has the same function as the network interface unit 16 in the multifunction device 100. In a predetermined operating system (OS), when an application program for the server is launched and loaded into the memory 24, the CPU 20 acts as a data management portion 20a, a DMS function portion (hereinafter, referred to as “second DMS”) 20b, and a network control portion 20c by executing this application program.

The data management portion 20a controls read operation of image data from the hard disk 22 and write operation of image data to the hard disk 22. The second DMS 20b acts as a DMS in a DLNA system (storage device in UPnP). The phrase “The second DMS 20b acts as a DMS in a DLNA system” means that the second DMS 20b has a substantial data storage device (hard disk 22) having a large storage capacity unlike the first DMS 10d in the multifunction 100. That is, the second DMS 20b transmits, receives, and stores contents, such as still images, and further performs content management on the basis of the standard UPnP AV v1.0. The server 200 corresponds to an image storage device in claims.

As described above, the multifunction device 100 includes the DMP 10c acting as a control point and the first DMS 10d acting as a storage device. Thanks to the structure, it is possible to carry out transmission and reception of image data obtained by scanning between the multifunction device 100 and the server 200 by using established methods because a method for allowing the control point to control the storage device (a method of transmission and reception of a control message) and a method of reading data from the storage device are established in UPnP (DLNA) architecture. Further, the invention can be applied to a future UPnP (DLNA) system. Still further, it is possible to enable peer-to-peer communication between the control point and the device. Yet further, if the control point and the device are the architecture for performing message exchange, the invention can be applied to network systems other than a UPnP (DLNA) system.

### A2: Image Saving Process

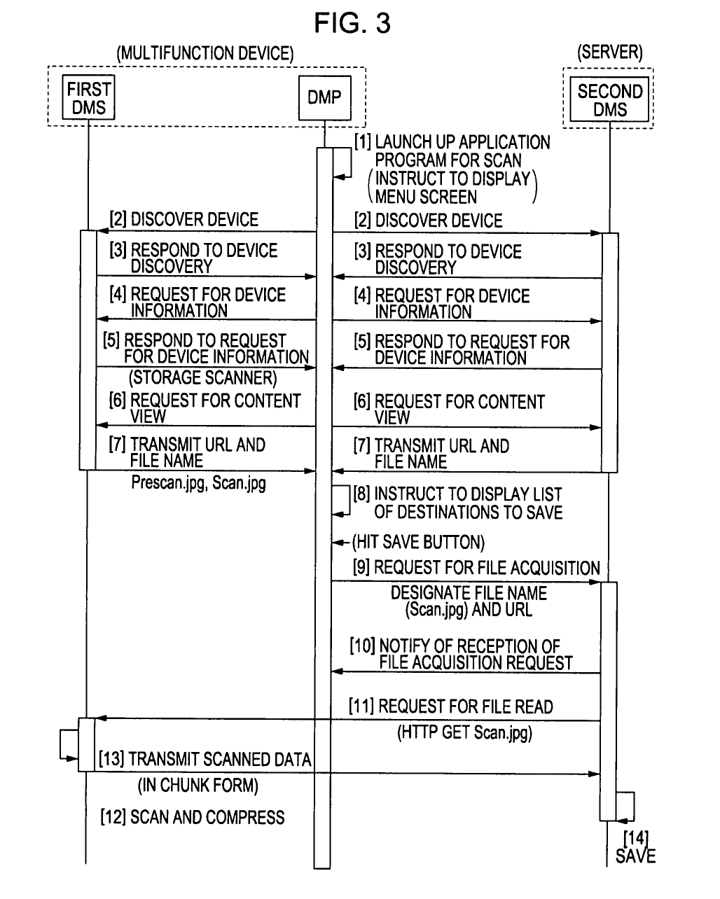

FIG. 3 shows a sequence of an image saving process in the image saving system 1000. As shown in FIG. 1, if a user arranges an image P1 at an image read position in the multifunction device 100 and selects a “scan” menu from an initial menu screen (not shown) displayed on the display unit 15 (shown in FIG. 2) by manipulating the manipulation unit 14, an application program is launched and the DMP 10c instructs the display control unit which is not shown in the figures to display a scan menu screen on the display unit 15 (Step [1]).

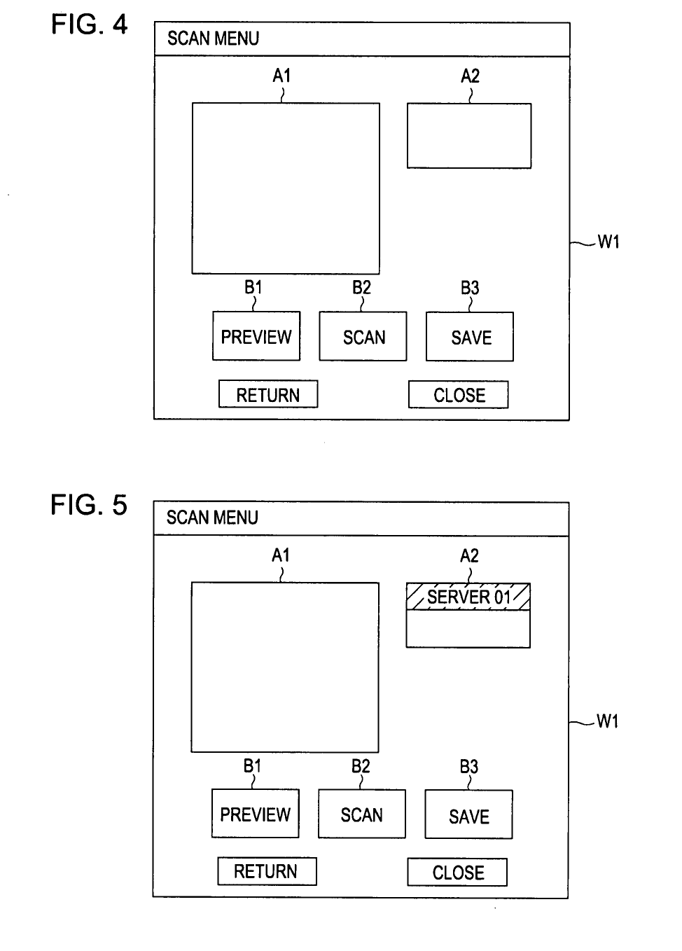

FIG. 4 is an explanatory view illustrating the scan menu screen displayed on the display unit 15 by Step [1]. The scan menu screen W1 includes an image display portion A1, a saving destination list display portion A2, a preview button B1, a scan button B2, and a save button B3. After performing Step [1], the image display portion A1 and the saving destination list display portion A2 are in the blank state.

In Step [2], the DMP 10c multicasts a discovery message to the local area network LAN1, thereby retrieving information on devices on the network, and also sends a discovery message to the first DMS 10d, thereby retrieving information on devices in the control circuit 10. In Step [3], the first DMS 10d of the multifunction device 100 and the second DMS 20b of the server 200 respond to the discovery messages. The device discovery/response can be achieved in a manner such that the second DMS 20b informs the DMP 10c of its joining when the server 200 joins the network. Further, it also can be achieved in a manner such that the first DMS 10d informs the DMP 10c of its joining when the multifunction device 100 is powered on.

In Step [4], the DMP 10c sends a request message for device information (device description), such as services provided by the device to the discovered devices (the first DMS 10d and the second DMS 20b). In Step [5], the first DMS 10d and the second DMS 20b send their device information to the DMP 10c in response to the request message for the device information. Here, in the device information sent by the first DMS 10d and the second DMS 20b, device type is designated as “storage.” The device information sent by the first DMS 10d includes a character string “storage scanner” as well as including the device type “storage” in order to advertise that the device is a particular scanner acting as an UPnP storage device.

In Step [6], the DMP 10c requests the first DMS 10d and the second DMS 20b to send a list of available contents. In Step [7], the first DMS 10d and the second DMS 20b send file names of the contents and Uniform Resource Locators (URLs) of saving destinations of the contents to the DMP 10c.

At this time, the first DMS 10d sends two file names “Prescan.jpg” and “Scan.jpg” to the DMP 10c. The file name “Prescan.jpg” is a reserved file name for the image data obtained by executing a pre-scan command. The file name “Prescan.jpg” is named by the multifunction device 100 and is a fixedly determined name. The file name “Scan.jpg” is a reserved file name for the image data obtained by executing a main-scan operation. The file name is named by the multifunction device 100 and is a fixedly determined name. In Step [6], at the time of requesting content view, the multifunction device 100 is in the state in which it has no available contents (image data) to provide since the pre-scan and the main-scan operations have not yet been executed in the multifunction device 100. However, after the pre-scan or main-scan operation is executed, still images with names of “Prescan.jpg” and “Scan.jpg” can be provided. Accordingly, the first DMS 10d sends file names “Prescan.jpg” and “Scan.jpg” which are fixedly designated names to the DMP 10c.

In Step [8], the DMP 10c instructs the display control portion which is not shown in figures to list saving destinations of the image data in the scan menu screen.

FIG. 5 is an explanatory view illustrating the scan menu screen W1 displayed on the display unit 15 by Step [8]. A device name of the server 200, “Server 01,” is displayed in the saving destination list display portion A2 of the scan menu screen W1. The device name is described in the device information sent by the second DMS 20b in Step [5]. The device name of the first DMS 10d is not displayed in the saving destination list display portion A2 for the following reason. That is, the DMP 10c judges that the first DMS 10d is not a substantial storage device which can store the image data on the basis of the device information sent by the first DMS 10d, which does not include the character string “storage scanner.” Accordingly, the device name of the first DMS 10d is not displayed.

Next, if a user hits the save button 3 by setting the device name “Server 01” as the saving destination from the scan menu screen W1 (shown in FIG. 5), an instruction which commands the multifunction device 100 to read an image and save image data to the server 200 is given to the multifunction device 100. In Step [9], the DMP 10c sends a file acquisition request which designates the file name “Scan.jpg” and the saving destination URL of the file to the server 200. This acquisition request can be executed as a result of a device control process using HTTP/Simple Object Access Protocol (SOAP). In Step [10], the second DMS 20b sends a reception response to the file acquisition request to the DMP 10c.

In Step [11], the second DMS 20b sends a read request message (HTTP GET method) for a file named “Scan.jpg” to the multifunction device 100, while designating the URL designated in Step [9]. The file read request corresponds to a file transmission request in claims.

In Step [12], the first DMS 10d instructs the read control portion 10a to read (main-scan) an image. The read control portion 10a reads an image P1 under a predetermined main-scan condition and produces image data. The first DMS 10d sequentially compresses the produced image data into the Joint Photographic Experts Group (JPEG) format and stores the compressed data in the data storage portion 10b while executing the main-scan operation instead of waiting until the main-scan is finished.

In Step [13], the first DMS 10d sequentially reads out the image data stored in the data storage portion 10b, encodes the image data in a chunk form, and sends the encoded image data to the server 200 so as to be saved as a file with a file name “Scan.jpg.” In the encoding process, random-size chunks of the file are sent to the server 200 one after another. At this time, the data size of each chunk is recorded in a header portion thereof, and the last chunk includes a description that the current chunk is the last chunk in a header portion thereof. Accordingly, the server 200 which receives the file can check whether it has received the entirety of the data without knowledge of the total file size in advance.

In Step [14], the second DMS 20b receives the file with the file name “Scan.jpg” and saves the file with the file name “Scan.jpg” in the hard disk 22 via the data management portion 20a.

As described above, since the first DMS 10d which is a DMS notifies the DMP 10c of a reserved file name and a URL of image data to be obtained by scanning, the DMP 10c can send a file acquisition request designating a file name and a URL to the second DMS 20b. When the second DMS 20b sends the file read request designating the file name and the URL to the first DMS 10d, the first DMS 10d executes a main-scan operation and sends back the image data with the designated file name. Consequently, it is possible to save the image P1 read by the multifunction 100 to the server 200. Since the multifunction device 100 executes image read operation after receiving the file read request and sequentially sends the image data to the server 200, it is possible to suppress the storage capacity of the data storage portion 10b to a small size.

### B: Second Embodiment

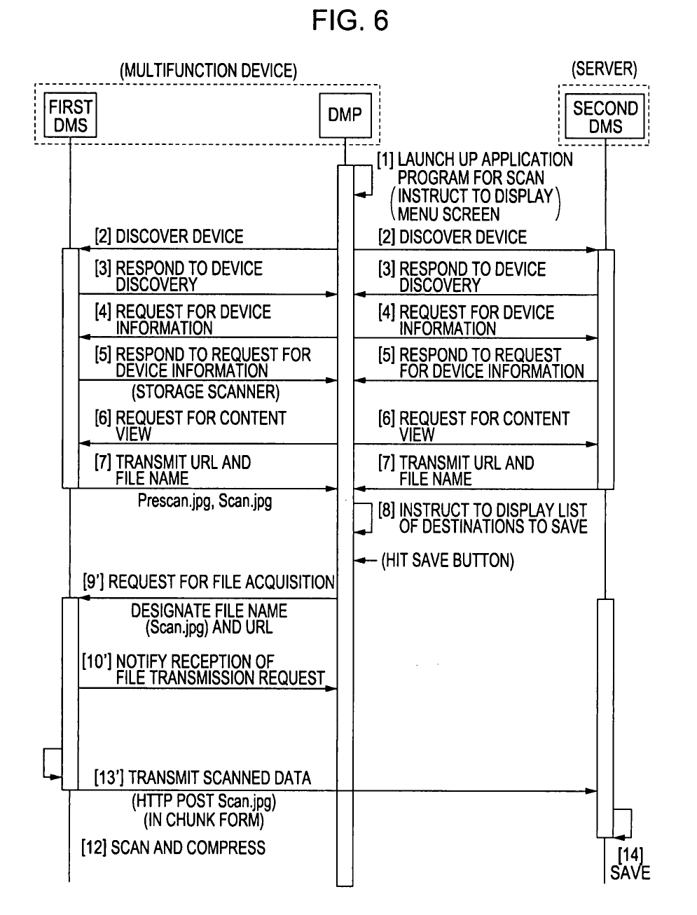

FIG. 6 shows a sequence of an image saving process according to a second embodiment. The sequence shown in FIG. 6 is different from the sequence shown in FIG. 3 in Steps [9], [10], [11], and [13]. Step [11] is deleted and Steps [9], [10], and [13] are modified, but the other steps are the same. The first embodiment has a structure in which the second DMS 20b sends the image data, responding to the file read request, but the second embodiment has a structure in which the first DMS 10d sends the image data to the server 200. Further, the structure of the image saving system according to the second embodiment is the same as the image saving system 1000 according to the first embodiment.

If an instruction which commands the multifunction device 100 to read an image and save image data to the server 200 is input to the multifunction device 100 when a user hits the save button B3 (shown in FIG. 5), the DMP 10c sends a transmission request for a file with the file name “Scan.jpg”, the transmission request designating the file name “Scan.jpg” and its URL, to the first DMS 10d in step [9′]. This transmission request can be executed by the device control process using HTTP/SOAP. The transmission request corresponds to a file transmission request in claims. In Step [10′], the first DMS 10d sends a reception response to the transmission request to the DMP 10c.

In Step [12], as in the first embodiment, the first DMS 10d compresses image data obtained by the main-scan operation and stores the compressed image data to the storage portion 10b. Next, in Step [13′], the first DMS 10d sequentially reads out the data stored in the data storage portion 10b, encodes the data in a chunk form, and sends the encoded data to the server 200 in a form of a file with a file name “Scan.jpg” using a HTTP/POST method. As a result, the second DMS 20b receives the file with the file name “Scan.jpg” and saves the file in the hard disk 22 via the data management portion 20a in Step [14].

In the above-mentioned structure, as in the first embodiment, it is possible to send the image data “Scan.jpg” obtained by scanning to the server 200, the image P1 read by the multifunction device 100 can be saved in the server 200.

### C: Modification

Among components in the above-mentioned embodiments, components other than components described in independent claims are optional components, and thus these optional components can be properly modified. Moreover, the invention is not limited to the above-mentioned embodiments and aspects but may be realized in various embodiments as long as they are in the scope which does not depart from the spirit of the invention. For example, the embodiments can be modified in the following manners.

### C1: First Modification

In the above-mentioned embodiments, a user designates “server 01” as a destination to save data using the scan menu screen W1 (shown in FIG. 5), and makes a save instruction which commands the server 200 to save the image data obtained by the main scan operation by hitting the save button B3. However, the user may check the image to be obtained by the main scan operation from the image display portion A1 before hitting the save button B3 and then hit the save button B3 after the checking. In this case, the user will hit the preview button B1 before hitting the save button B3. When the preview button B1 is hit, the DMP 10c instructs the read control portion 10a to perform a pre-scan operation. The read control portion 10a reads the image P1 under a predetermined pre-scan condition, and stores image data to the data storage portion 10b as a file with the file name “Prescan.jpg.” The DMP 10c instructs the display control portion (not shown) to display an image while designating the file name “Prescan.jpg.” The display control portion (not shown) reads the file with the file name “Prescan.jpg” from the data storage portion 10b and displays it on the display unit 15. Thanks to the structure, the user can save the image to the server 200 after checking the image to be obtained by scanning.

### C2: Second Modification

In the above-mentioned embodiments, the multifunction device 100 has a structure including the DMP 10c, but may have a structure including a Digital Media Controller (DMC) function portion specified by the DLNA. The DMC also can send the control message to the DMS as the DMP does. Accordingly, it is possible to instruct the DMS 10d and the DMS 20b to acquire and send image data obtained by scanning as in the above-mentioned embodiments.

### C3: Third Modification

In the above-mentioned embodiments, the image data obtained by the main-scan operation is sent after it is encoded into a chunk form. However, the image data may be transmitted lacking encoding into the chunk form. In greater detail, in Step [7], the server 200 is notified to receive a file with an excessively large size which is larger than a substantial size, and then dummy data is added to a substantial data file upon sending the substantial data file so that the total size of the file received by the server 200 becomes equal to the notified file size. In this way, the method in which an excessively large size is notified upon notifying and dummy data is added to the image data upon transmitting the image data is used due to the following reason. That is, since the multifunction device 100 sequentially transmits the image data obtained by scanning before the main-scan operation is completed, in the case in which a small size is notified at an early stage, a substantial file size which is the total size of the sequentially transmitted file becomes larger than the notified file size. As a result, it can happen that the server 200 on a receiver side cannot properly treat the received data.

### C4: Fourth Modification

In the multifunction device 100 according to the first embodiment, the image read operation is carried out after reception of the read request message (Step [11]). However, the timing of executing the image read operation is not limited to the exemplified timing. That is, the timing may be any time after an instruction to command the server 200 to read the image and store the image data is given to the multifunction 100, in which the instruction is given to the server 200 when the user hits the save button B3 (shown in FIG. 5). For example, the image saving system may be structured in a manner such that the image read operation is carried right before or simultaneously with Step [9]. Thanks to the structure, the first DMS 10d in the multifunction device 100 immediately starts to send the image data when the server 200 (the second DMS 20b) receives the file read request. Further, also in the second embodiment, the image read operation can be carried at any time after the instruction to command to read the image and store the image data to the server 200 is given to the multifunction device 100 when the user hits the save button B3.

### C5: Fifth Modification

In the first embodiment, the DMP 10c designates the file name and a saving destination URL by the file acquisition request (Step [9]) sent to the server 200, but alternatively may designate only the file name instated of designating both. In the structure, the saving destination URL in the multifunction device 100 is a fixed URL, and the fixed URL may be set in the server 200 in advance. In this case, in Step [11], the second DMS 20b may be adapted to send the file read request designating only the file name. In the same manner, in the second embodiment, in Step [9′], the DMP 10c may have a structure in which the DMP 10c sends the file transmission request designating only the file name lacking the saving destination URL. In these structures, it is possible to request the server 200 (the second DMS 20b) and the first DMS 10d for image data acquisition and transmission.

### C6: Sixth Modification

In the above-mentioned embodiments, the image saving system 1000 is a DLNA system based on UPnP. However, the image saving system according to the invention may be a system performing image transmission using Picture Transfer Protocol/Internet Protocol (PTP/IP) instead of the DLNA system. The PTP/IP is image transmission protocols drawn by the Camera & Imaging Products Association (CIPA). The PTP/IP enables transmission of image data between two devices of an initiator and a responder. Examples of the initiator and the responder include a digital still camera, a personal computer, a printer, or the like. In this structure, the multifunction device 100 acts as the responder, and scans an image and sends image data when a processing request which designates a predetermined file name is given. Accordingly, it is possible to save the image obtained by scanning to the server 200 acting as the initiator.

### C7: Seventh Modification

Part of the structure realized in a hardware form in the above-mentioned embodiments may be also realized in a software form. Conversely, part of the structure realized in a software form in the embodiments may be also realized in a hardware form.

What is claimed is:

1. An image saving system for reading and saving an image, comprising:
an image storage device; and
a scanner device connected to the image storage device via a network;
wherein the scanner device includes a read unit which reads an image and produces image data, a control point unit which acts as a control point in network plug-and-play, and a device unit,
wherein the device unit notifies the control point unit that the device unit is a storage device in the network plug and play, and
wherein the device unit sends the image data with a predetermined reserved file name to the image storage device and saves the image data with the predetermined reserved file name to the image storage device when the device unit receives a file transmission request which designates the predetermined reserved file and is sent in response to a user's instruction which commands the device unit to save the image data obtained by allowing the scanner device to read the image mounted on the scanner device to the image storage device.

2. The image saving system, according to claim 1, wherein the device unit produces the image data by allowing the read unit to read the image after reception of the file transmission request.

3. The image saving system, according to claim 1, wherein the image storage device acts as the storage device in the network plug and play, the control point unit acquires the reserved file name from the device unit and sends the reserved file name to the image storage device, and the image storage device sends the file transmission request to the device unit.

4. The image saving system according to claim 1, wherein the control point unit acquires the reserved file name from the device unit and sends the file transmission request to the device unit.

5. A scanner device connected to an image storage device via a network, comprising:
a read unit for reading an image and producing image data;
a control point unit acting as a control point in network plug and play; and
a device unit,
wherein the device unit notifies the control point unit that the device unit is a storage device in network plug and play and wherein the device unit sends the image data with a predetermined reserved file name to the image storage device and saves the image data with the predetermined reserved file name to the image storage device when the device unit receives a file transmission request which designates the predetermined reserved file name and is sent in response to a user's instruction which commands the device unit to read the image mounted on the scanner device and save the image data to the image storage device.

6. An image saving method for reading and saving an image in an image saving system including an image storage device and a scanner device connected to the image storage device via a network, in which the scanner device includes a read unit for reading an image and producing image data, a control point unit acting as a control point in network plug-and-play, and a device unit, comprising:
(a) allowing the device unit to notify the control point unit that the device unit is a storage device in the network plug-and-play;
(b) allowing the device unit to send the image data with a predetermined reserved file name to the image storage device and save the image data with the predetermined reserved file name to the image storage device when the device unit receives a file transmission request which designates the predetermined reserved file name and is sent in response to a user's instruction which commands to the device unit to read the image mounted on the scanner device and save the image data to the image storage device.
